(19) United States
(12) Patent Application Publication
(10) Pub. No.: US 2009/0208665 A1
(43) Pub. Date: Aug. 20, 2009

(54) Device and a Method for Controlling Thickness

(75) Inventors: Jan Erik Eriksson, Vasteras (SE); Conny Svahn, Vasteras (SE); Rebei Bel Fdhila, Vasteras (SE); Bengt Rydholm, Vasteras (SE)

Correspondence Address: VENABLE LLP, P.O. BOX 34385, WASHINGTON, DC, 20043-9998, US

(73) Assignee: ABB AB, Vasteras (SE)

(21) Appl. No.: 11/922,504

(22) PCT Filed: Jun. 19, 2006
(86) PCT No.: PCT/SE2006/000737

§ 371 Date: Dec. 19, 2007

Related U.S. Application Data
(60) Provisional application No. 60/695,205, filed on Jun. 30, 2005.

(30) Foreign Application Priority Data
Dec. 22, 2005 (SE) 0502861-8

(51) Int. Cl. B05C 9/08; C23C 2/24

(52) U.S. Cl. 427/547; 118/639

(57) ABSTRACT

A device for controlling the thickness of a metallic coating on an elongated metallic element formed by continuously transporting the element through a bath of molten metal. The device includes at least one pair of electromagnetic wiper members and a second wiper member associated with the at least one pair of electromagnetic wiper members. The second wiper member is designed to apply to the element a jet of gas with a target area essentially according to a line transversely of the element with respect to the direction of the transport path in order to assist the electromagnetic wiper member in the wiping of superfluous molten metal from the element.

### TECHNICAL FIELD AND BACKGROUND ART

The present invention relates to a device for controlling the thickness of a metallic coating on an elongated metallic element formed by continuously transporting the element through a bath of molten metal, the element being intended to be transported from the bath in a transport direction along a predetermined transport path, wherein the device comprises at least one pair of electromagnetic wiper members designed to be arranged along said transport path on each side of an element, transported along said path, for wiping off superfluous molten metal from the element by applying a travelling magnetic field onto the molten metal on the element, and to a method for such thickness control.

Such a device and such a method are especially advantageous in continuous galvanization of a metallic strip. The present invention will hereafter be described with reference to such an application. However, it should be noted that the invention is also applicable to the galvanization of other metallic objects, such as wires, rods, tubes, or other elongated elements. The invention is also applicable to the coating of an elongated metallic element with other coatings than zinc, for example tin or aluminium, or mixtures of these or other metals.

During continuous galvanization of a metallic strip, for example a steel strip, the steel strip continuously passes through a bath that contains molten metal, usually zinc. In the bath, the strip usually passes below an immersed roller and then moves upwards through stabilizing and correcting rollers. The strip leaves the bath and is conveyed through a wiper device, such as a device of the kind defined in the introduction. In this context, the travelling magnetic field is used to control the thickness of the coating and to wipe off superfluous zinc fro the metal strip. Surplus zinc returns to the bath and can thus be reused. The strip is then transported without support until the coating has been cooled down and solidified. The coated strip is then led or directed via an upper roller to an arrangement for cutting of the strip into separate strip elements or for winding the strip onto a roller. Usually, the strip moves in a vertical direction away from the immersed roller through the correcting and stabilizing rollers and the wiper device to the upper roller.

When steel strip is galvanized, a uniform and thin thickness of the coating is aimed at. One common method of checking the thickness of the coating after superfluous molten metal has been wiped off, and the coating has solidified, is to measure the mass of the coating after the strip, for example, has passed through the upper roller. This reading is utilized for controlling the wiper device and hence regulating the thickness of the coating.

The magnitude of the wiping force that is applied to the element via the wiper member of said device is decisive for how thin a coating that may be achieved at a given speed of the element along the transport path. This means that when very thin coatings are desired, such as in the order of magnitude of 10 μm, the element has to be run at a lower speed than what would be desirable for an efficient strip production. The maximum wiping force of said electromagnetic wiping member is restricted by the fact that saturation occurs in the iron core exhibited by said wiper member, which limits the magnetic flux and hence the force. Further, the travelling magnetic field generates a transverse electric current in the liquid metal coating on the element, and this turns in the vicinity of the side edges of the element, such that the wiping force at that point becomes lower and hence the coating thicker at the edges.

Thus, a device of the kind initially defined exhibits certain limitations with regard to achieving a thin metal coating with a uniform thickness over the whole width of the element while maintaining a high production efficiency.

It can also be mentioned here that another type of device with the same purpose is known, namely, a device which, instead of applying a travelling magnetic field to the element, applies a jet of gas with a target area essentially according to a line transversely over the element for wiping off superfluous molten metal from the element. One disadvantage of this type of device is that the possible speed of the jet of gas is limited by the acoustic velocity, such that the element normally has to be run slowly to reduce the thickness of the coating of metal to the desired level. Another disadvantage when using such a so-called gas-knife for wiping off superfluous molten metal from the element is that this type of wiping normally results in a thicker coating in the central section of the element and a thinner coating at the side edges of the element due to turbulences that arise in the gas jet. If, in addition, a said gas jet is applied with too high a pressure, droplets in the coating, so-called splashing, will occur, which deteriorates the quality of the coating.

### SUMMARY OF THE INVENTION

The object of the present invention is to provide a device and a method of the initially defined kind, which at least partly eliminate the above-mentioned disadvantages of prior art such devices and methods.

This object is achieved according to the invention with regard to the device by providing a device of the initially described kind, associated with the respective electromagnetic wiper member, with a second wiper member designed to apply to the element a jet of gas with a target area essentially according to a line transversely of the element with respect to the direction of the transport path for assisting the electromagnetic wiper member in the wiping away of superfluous molten metal from the element.

A said electromagnetic wiper member and a wiper member based on a gas jet operate completely independently of each other, so that, if desired, the maximum possible force may be applied via the electromagnetic wiper member and at the same time the maximum possible force may be applied via the gas jet of the second wiper member. In this way, twice the wiping force may be achieved in such a device in relation to a device that only has either electromagnetic wiper members or wiper members based on a gas jet. This means that it will be possible, for a given desired thickness of the metal coating, to increase the speed at which the element is transported along said transport path and hence the rate of production of the product, such as strip or the like, that is produced based on the element.

By combining the two above-mentioned wiping methods, also other advantages are achieved. One such advantage is derived from the fact that the gas jet has a cooling effect on the metal coating, whereas the travelling magnetic field has a warming effect thereon, which means that these two effects to a certain extent neutralize each other, so that the effect of the wiper member on the rate of cooling of the coating is reduced, which results in improved quality of the coating. Further, said second wiper member tends to apply higher wiping forces near the side edges of the element via the gas jet, whereas the electromagnetic wiper member there applies lower wiping forces than in the central portion of the element, so that these two effects together result in a uniform thickness of the coating in the transverse direction of the element. Further, the travelling magnetic field suppresses the above-mentioned so-called splashing caused by the gas jet, since the magnetic field has a calming effect on such movements in the molten metal coating.

According to one embodiment of the invention, the respective electromagnetic wiper member and the second wiper member collaborating therewith are adapted to apply the wiping force to said element within essentially the same region of the element. In this way, the above-mentioned combinatory advantages of using these two types of wiper members may be utilized to a maximum. Thus, it is advantageous for said second wiper member to be adapted to apply said gas jet onto the element at a location along said transport path located in essentially the same position as the application of wiping forces by the electromagnetic wiper member collaborating therewith, or in the direction of the transport path essentially immediately downstream of said position. If it is possible to apply the wiping forces of the two wiper members so as to be, in principle, at a maximum at the same points, then in most cases a maximum effect of the above-mentioned advantages of combining them will be achieved.

In this context, it has proved to be advantageous for said second wiper member to be adapted to apply said gas jet onto the element at a point that is located along said transport path at a distance of less than 10 cm, preferably less than 5 cm, from the position in which the wiping force emanating from said cooperating electromagnetic wiper member is at its maximum. It is particularly advantageous, as mentioned, if said second wiper member is adapted to apply said gas jet onto the element at a point along said transport path located in essentially the same position as that in which the electromagnetic wiper member cooperating therewith is adapted to apply maximum wiping forces.

According to another embodiment of the invention, the second wiper member is designed to apply a jet of air onto the element, which implies a cost-effective realization of said jet of gas.

According to another embodiment of the invention, the respective second wiper element is designed to apply a jet of nitrogen gas onto the element, which is advantageous if an oxidation of the material in the applied metal coating must be avoided to the utmost possible extent.

According to another embodiment of the invention, each electromagnetic wiper member comprises a wiper pole formed from a magnetic core. In that case, according to a further embodiment of the invention, the second wiper member may comprise a gas nozzle arranged in said magnetic core, which makes it possible to achieve an application of wiping forces derived from the gas jet and the travelling magnetic field at essentially the same point on the element.

According to another embodiment of the invention, said magnetic core is designed to form, with portions thereof, said nozzle, and according to still another embodiment of the invention, said magnetic core exhibits an inner cavity in which a separate part forming said nozzle is received. Which of these two embodiments to be preferred may be dependent on the intended use of the device according to the invention.

According to another embodiment of the invention, the device comprises at least one pair of electromagnetic stabilizing members comprising one stabilizing member on each side of the transport path for the element to stabilize the position of the element with respect to the predetermined transport path, and the stabilizing member comprises a stabilizing pole. When the element is a mentioned metal strip, the geometry of this strip, the length that the strip has to run without support, its speed and the influence from the wiper members will cause the metal strip to move or vibrate in a direction that is essentially perpendicular to its transport direction. Said vibrations of the strip may be reduced extensively through said electromagnetic stabilizing member, thus achieving improved quality of the coated strip.

According to another embodiment of the invention, the respective electromagnetic wiper member and the stabilizing member on the same side of said transport path are arranged such that the wiper pole and the stabilizing pole coincide. This causes the stabilizing magnetic force from the stabilizing member to act in the same region as the disturbing force from the electromagnetic wiper member. Since the stabilizing force acts in the same region as the disturbance on the strip from the wiper member, reduced bending and vibrations of the element are achieved. Another advantage of the relative arrangement of the stabilizing member and the electromagnetic wiper member is that the device becomes compact. The wiper member and the stabilizing member then advantageously have a common magnetic core.

The invention also relates to a method for controlling the thickness of a metal coating on an elongated metallic element, whereby the coating is applied by continuously transporting the element through a bath of molten metal, the method comprising:
transporting the element in a transport direction along a predetermined path, and
wiping off superfluous molten metal from the elongated metallic element by applying to the element with the still not solidified metallic coating a travelling magnetic field and a jet of gas with a target area essentially according to a line transversely of the element with respect to the direction of the transport path on the element with the still not solidified metallic coating.

The advantages and the advantageous features of such a method will be clear from the above description of the device according to the invention.

According to one embodiment of the invention, the method comprises measuring the thickness of the coating after wiping off superfluous molten metal, whereby a difference between the measured thickness and a desired value of the thickness controls a) the current passing to phase windings that generate the travelling magnetic field, and/or b) the pressure of said jet of gas applied to the element. In this way, it can be ensured in a reliable manner than the desired thickness of the coating is attained.

According to another embodiment of the invention, the current passing to phase windings that generate the travelling magnetic field and the application of said jet of gas are adapted to each other so that the total wiping force formed from these two factors, applied to the element, becomes essentially equally great over the width of the element, that is, along the element in the transverse direction relative to the direction of said transport path. In this way, it is ensured that the thickness of the later solidified coating becomes essentially the same at the end portions of the element as at is mid-portion.

According to another embodiment of the invention, the jet of gas is preheated for removing moisture therefrom before it is applied as a jet onto said element, which implies that the jet of gas will not cool to the same extent and that no moisture is applied to the molten metal, and these two features may be requested in certain types of applications.

Additional advantages and advantageous features of the invention will be clear from the following description and from the other dependent claims.

### BRIEF DESCRIPTION OF THE DRAWINGS

Preferred embodiments of the invention, described as examples, will be described in the following with reference to the accompanying drawings, wherein:

FIG. 1 is a very simplified cross-section view through one embodiment of a device for controlling the thickness of a metallic coating on a metal strip, as viewed from the side,

FIG. 2 is a very simplified detail view of that region of a metal strip coated with molten metal in which wiper forces are applied to the coating,

FIG. 3 is a view from the front of part of a device according to the invention, including electromagnetic wiper members and wiper members with a jet of gas,

FIG. 4 is a simplified cross-section view along the line B-B in FIG. 3, and

FIG. 5 is a view corresponding to FIG. 4 of a device according to a second embodiment of the invention.

### DETAILED DESCRIPTION OF PREFERRED EMBODIMENTS OF THE INVENTION

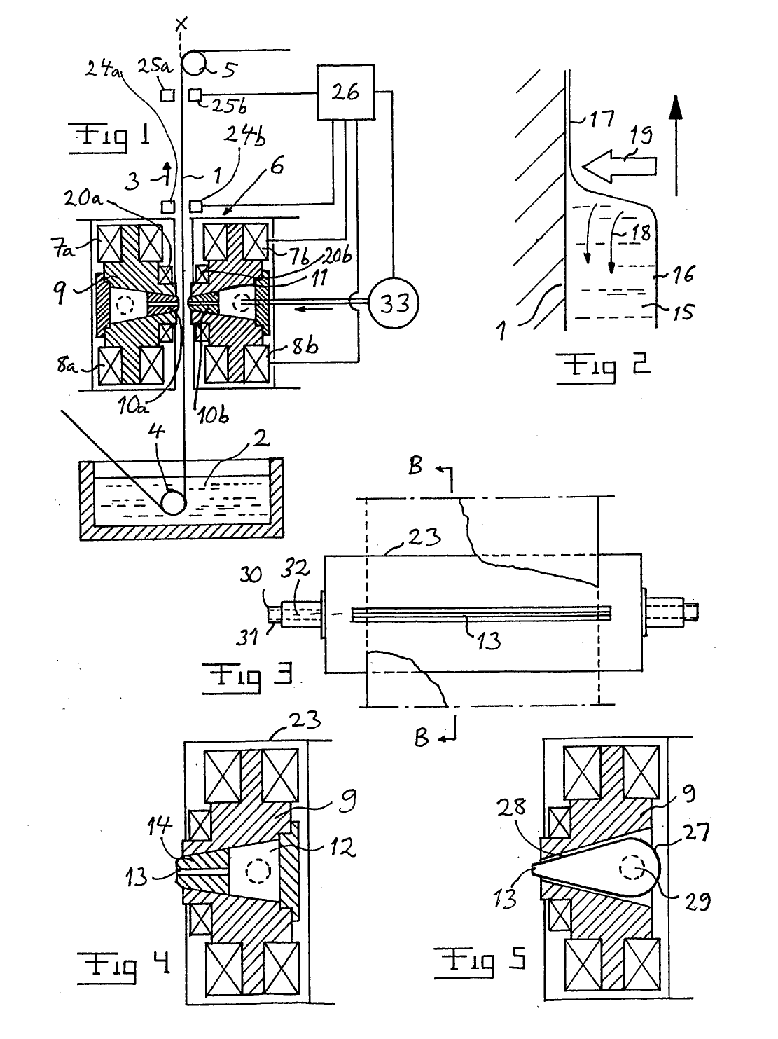

FIG. 1 schematically shows a device according to one embodiment of the invention for controlling the thickness of a metallic coating on an elongated metallic element 1 in the form of a strip. The strip 1 is coated with a layer of molten metal by continuously transporting the strip through a molten metal bath 2. The strip is transported from the bath in a transport direction 3 along a predetermined transport path x. The predetermined transport path x extends substantially between a roller 4 immersed into the bath 2 and an upper roller 5, which is arranged after a wiper and stabilizing unit 6, which is adapted to wipe off superfluous molten metal from the strip 1 and to stabilize the strip. This unit exhibits two identical halves a, b, arranged on respective sides of the transport path x for influencing the strip from opposite directions. The device comprises, on each side of the transport path x, an electromagnetic wiper member formed from a first phase winding 7a, 7b for a first phase and a second phase winding 8a, 8b for a second phase, the phase windings being arranged around a magnetic core 9a, 9b which comprises a wiper pole 10a, 10b directed towards the transport path x and hence towards a strip 1 running along said path. The electromagnetic wiper member thus formed operates as follows. The phase windings 7a, 7b, 8a, 8b are fed with alternating current (not shown) and generate an alternating magnetic field, also called travelling magnetic field, on the strip 1. Said magnetic field induces current paths (not shown) in the coating and a force acting on the coating in a direction opposite to the transport direction of the strip. In this way, superfluous coating material is wiped off in a longitudinal direction of the strip.

Reference will now also be made to FIGS. 3 and 4. The device further comprises, on each side of the transport path, a second wiper member 11 designed to apply to the strip 1 a jet of gas with a target area according to a line transversely of the strip with respect to the direction of the transport path for assisting the electromagnetic wiper member in the wiping of superfluous molten metal from the strip. How this second wiper member may be designed is clear from FIGS. 3 and 4. The device comprises an arrangement 33 adapted to feed gas, such as, for example, air or nitrogen gas, with a high pressure into a gas chamber 12 formed inside the magnetic core 9. The gas chamber 12 is adapted to extend in the transverse direction of the transport path over the entire width of the strip and opens out inwards via a narrow gas nozzle 13 directed towards the transport path, that is, towards the strip, for forming said jet of gas with a line-like target area on the strip. In the embodiment shown in FIG. 4, the gas nozzle 13 is formed from a part 14 of the magnetic core itself. By this arrangement of the so-called gas-knife inside the magnetic core of the electromagnetic wiper member, the wiping forces emanating from the jet of gas and the electromagnetic wiper member will essentially coincide.

FIG. 2 schematically illustrates how the coating 15 decreases in thickness by the action of the two wiper members; the thickness may be, for example, 100 μm in part 16 upstream of the point of application of the wiper members on the coating, and may thereafter decrease in part 17 to perhaps 10 μm. Here, the forces derived from the electromagnetic wiper member are indicated by the arrows 18, whereas the influence of the jet of gas is indicated by the arrow 19. At a given speed of the strip along the transport path, which is preferably in the order of magnitude of 200 metres per minute, the achievable thickness of the coating after having passed the point of application of the wiper members is approximately F^{-1/2}, wherein F is the wiping force. Since the wiping force may almost be doubled by combining the two types of wiper members, a reduction in thickness in the order of magnitude of 30% may be achieved at an unchanged speed of motion of the strip, that is, for a given thickness, the strip may be run considerably faster. In addition, a number of other combinatory advantages are achieved, as described above, by simultaneously using these two types of wiper members.

The device further comprises, on each side of the transport path x, an electromagnetic stabilizing member 20a, 20b in the form of a stabilizing winding wound around the same magnetic core 10a, 10b as the phase windings, so that a common wiper and stabilizing pole 10a, 10b is achieved.

The respective stabilizing winding 20a, 20b is fed with a direct current so that a stabilizing force acts perpendicular to the strip 1. Since the stabilizing pole 10a, 10b is adapted to cooperate with the wiper pole, the stabilizing force may act on the strip in the same region as that in which a disturbance from the wiper pole arises. Disturbances and vibrations may, of course, arise in other ways than from the wiper member, for example due to the free length of the strip 1, that is, the length along which the strip 1 is running without support. Also these disturbances or vibrations may be stabilized with the stabilizing member. The wiper and stabilizing pole 10a, 10b is arranged at a determined distance from the predetermined transport path x. The distance of course varies with the current thickness of the strip 1 and the thickness of the coating.

The entire unit for wiping and stabilizing is arranged inside a common so-called wiper housing 23 (see FIGS. 3 and 4). By enclosing the two types of wiper members in this way in the same mechanical unit, these act jointly so that all equipment for positioning perpendicular to the transport path x, adjustment of the angle between the jet of gas and the transport path etc. is used in common. This eliminates a costly double arrangement of such equipment.

FIG. 1 shows that a sensor 24a, 24b for sensing the position of the strip 1 in relation to its predetermined transport path x is arranged on either side of the strip 1. The sensor 24a, 24b is arranged in the vicinity of the wiper and stabilizing unit 6. The sensor is adapted to detect the value of a parameter that is dependent on the position of the strip with respect to the predetermined transport path x, whereby the stabilizing member is designed to apply a force to the strip 1 that corresponds to the detected value.

The device is further provided with an arrangement 25a, 25b for measuring the thickness of the layer after it has solidified. This control arrangement 25a, 25b is adapted to send signals corresponding to the thickness of the layer to a control unit 26 adapted, in dependence on the measured result, to control the current feed to the phase windings 7a, 7b and 8a, 8b used for the wiping and the gas supply arrangement 33 for setting the total wiping force so that the desired thickness of the coating is achieved.

FIG. 5 illustrates a device according to a second embodiment of the invention, which differs from that shown in FIG. 4 in that parts of the magnetic core 9a, 9b are not used for forming the gas nozzle, but said nozzle is formed from a separate part 27 received in a cavity 28 in the magnetic core. The gas is here supplied via an elongated tube 29 with openings evenly distributed in its mantle to direct a jet of gas out through the nozzle 13. It is clear from FIG. 3 how the gas, as the air, may be fed into the gas chamber 12 and the tube 29, respectively, through a gas connection member 30 at the ends of the wiper housing 23. The whole housing 23 is also journalled there at 31 to be capable of being pivoted about the axis 32, in order thus to change the direction according to which the wiper forces will attack the coating on the element that passes through the electromagnetic wiper member and the gas-jet wiper member.

The invention is not, of course, in any way restricted to the embodiments described above; on the contrary, a number of possible modifications thereof will be obvious to a person skilled in the art, without this person for that reason departing from the basic inventive concept as defined in the accompanying claims.

For example, it is not absolutely necessary for the device to exhibit stabilizing members, although in most cases it is probably advantageous. Further, the device could exhibit more than one electromagnetic wiper member on each side of the elongated metallic element, and the same applies to said second wiper member.

It would also be possible for electromagnetic wiper members located on respective sides of the transport path, and/or other gas-jet wiper members, to be divided into several parts arranged in different positions in latitudinal direction of a strip or the like that is intended to pass through these members, in which case the different parts may possibly be individually controllable to change the wiping force in some limited part of the strip with respect to its transverse direction, such as in an edge portion or in a centre part of the strip.

1. A device for controlling the thickness of a metallic coating on an elongated metallic element formed by continuously transporting the element through a bath of molten metal, wherein the element is intended to be transported from the bath in a transport direction along a predetermined transport path, the device comprising:
at least one pair of electromagnetic wiper members designed to be arranged along said transport path on each side of an element transported along said path for wiping off superfluous molten metal from the element by applying a travelling magnetic field onto the molten metal on the element, and
a second wiper member associated with the respective electromagnetic wiper member, said second wiper member being designed to apply to the element a jet of gas with a target area essentially according to a line transversely of the element with respect to the direction of the transport path in order to assist the electromagnetic wiper member in the wiping of superfluous molten metal from the element.

2. The device according to claim 1, wherein the respective electromagnetic wiper member and the second wiper member cooperating therewith are adapted to apply wiping forces to said element within essentially the same region of the element.

3. The device according to claim 2, wherein said second wiper member is adapted to apply said jet of gas to the element at a location along said transport path located essentially in the same position as the application by said electromagnetic wiper member of wiping forces or in the direction of the transport path essentially immediately downstream thereof.

4. The device according to claim 3, wherein said second wiper member is adapted to apply said jet of gas to the element at a location which along said transport path is located at a distance less than 10 cm from the position in which the wiping force derived from said cooperating electromagnetic wiper member is at its maximum.

5. The device according to claim 2, wherein said second wiper member is adapted to apply said jet of gas to the element at a location along said transport path located in essentially the same position as that in which the electromagnetic wiper member cooperating therewith is adapted to apply maximum wiping forces.

6. The device according to claim 1, wherein the respective second wiper member is designed to apply a jet of air to the element.

7. The device according to claim 1, wherein the respective second wiper member is designed to apply a jet of nitrogen gas to the element.

8. The device according to claim 1, wherein each of the electromagnetic wiper members comprises a wiper pole formed from a magnetic core.

9. The device according to claim 8, wherein the respective second wiper member comprises a gas nozzle arranged in said magnetic core.

10. The device according to claim 9, wherein said magnetic core is designed to form, with portions thereof, said nozzle.

11. The device according to claim 9, wherein said magnetic core exhibits an inner cavity in which a separate part, which forms a nozzle, is received.

12. The device according to claim 1, further comprising:
at least one pair of electromagnetic stabilizing members, comprising one stabilizing member on each side of the transport path for the element for stabilizing the position of the element with respect to the predetermined transport path, and wherein each stabilizing member comprises a stabilizing pole.

13. The device according to claim 12, wherein the respective electromagnetic wiper member and the stabilizing member on the same side of said transport path are arranged so that the wiper pole and the stabilizing pole coincide.

14. The device according to claim 13, wherein the electromagnetic wiper member and the stabilizing member have a common magnetic core.

15. A method for controlling the thickness of a metallic coating on an elongated metallic element, wherein the coating is applied by continuously transporting the element through a bath of molten metal, the method comprising:
transporting the element in a transport direction along a predetermined path, and
wiping off superfluous molten metal from the elongated metallic element by applying to the element with the still not solidified metallic coating a travelling magnetic field and a jet of gas with a target area essentially according to a line transversely of the element with respect to the direction of the transport path on the element with the still not solidified metallic coating.

16. The method according to claim 15, wherein the elongated metallic element is a metallic strip.

17. The method according to claim 15, further comprising:
measuring the thickness of the coating after wiping off superfluous molten metal, whereby a difference between the measured thickness and a desired value of the thickness controls a) the current passing to phase windings that generate the travelling magnetic field, and/or b) the pressure of said jet of gas applied to the element.

18. The method according to claim 15, wherein the current flowing to phase windings that generate the travelling magnetic field and the application of said jet of gas are adapted to each other so that the total wiping force, formed from these two factors, applied to the element becomes essentially equally great over the width of the element, that is, along the element in the transverse direction relative to the direction of said transport path.

19. The method according to claim 15, wherein the travelling magnetic field and said jet of gas are applied such that the wiping forces derived therefrom are applied to said element within essentially the same region of the element.

20. The method according to claim 15, wherein said jet of gas is applied to the element at a location along said transport path located in essentially the same position as the wiping forces that are applied to the element through the travelling magnetic field, or in the direction of the transport path essentially immediately downstream of this.

21. The method according to claim 20, wherein said jet of gas is applied to the element at a location along said transport path that is located at a distance less than 10 cm from the position in which the wiping force derived from said travelling magnetic field is at its maximum.

22. The method according to claim 15, wherein said jet of gas is applied to the element at a location along said transport path located in essentially the same position in which the travelling magnetic field is arranged to apply maximum wiping forces to the element.

23. The method according to claim 15, wherein said jet of gas is a jet of air.

24. The method according to claim 15, wherein said jet of gas is a jet of nitrogen gas.

25. The method according to claim 15, wherein the gas for the jet of gas is preheated for removing moisture therefrom before it is applied as a jet to said element.
